(19) United States
(12) Patent Application Publication
(10) Pub. No.: US 2015/0366406 A1
(43) Pub. Date: Dec. 24, 2015

(54) DRINK MIXER

(71) Applicant: Roger Leopold Hilscher, Sunbury, PA (US)

(72) Inventor: Roger Leopold Hilscher, Sunbury, PA (US)

(21) Appl. No.: 14/309,540

(22) Filed: Jun. 19, 2014

(51) Int. Cl. A47J 43/27

(52) U.S. Cl. CPC A47J 43/27; A47J 2043/04427

(57) ABSTRACT

A drink mixer including a cup with an internal cavity is provided. An inner assembly is located within the internal cavity of the cup. The inner assembly includes a hollow cylinder with a hollow coil tube attached to and surrounding the hollow cylinder. The coil tube may include a top opening and a bottom connected to the cylinder and leading into the hollow core of the cylinder. The inner assembly may be in a first position in which the inner assembly is adjacent the opening of the cup, and a second position which the inner assembly is adjacent to the base of the cup. In use, beverages may be poured in the coil tube through the opening, as well as in the hollow core of the cylinder. Ice may also be placed within the hollow core of the cylinder. The inner assembly may be rotated between the first position and the second position to mix the beverage within the cup.

### BACKGROUND OF THE INVENTION

The present invention relates to mixed drinks and, more particularly, to a drink mixer for patrons.

A mixed drink is a beverage in which two or more ingredients are mixed. Some mixed drinks contain liquor; others are non-alcoholic. A cocktail shaker is a device used to mix beverages (usually alcoholic) by shaking. When ice is put in the shaker, this allows for a quicker cooling of the drink before serving. Usually, the mixed drink is prepared in the cocktail shaker and then poured into a glass to be served to a patron. However, glasses tend to be uninteresting and cocktail shakers must be constantly washed between drinks.

As can be seen, there is a need for a drink mixer that may be used by each patron.

### SUMMARY OF THE INVENTION

In one aspect of the present invention, a drink mixer comprises: a cup comprising a base portion and a sidewall with a rim forming an opening into an internal cavity within the cup; a cylinder within the internal cavity, the cylinder comprising a top end, a bottom end, and a hollow core; and a coil tube surrounding the cylinder, wherein the coil tube comprises a first end comprising an opening near the top end of the cylinder, and a second end connected to the cylinder near the bottom end leading into the hollow core; wherein the cylinder comprises a first position wherein the top end of the cylinder is near the opening of the cup, and a second position, wherein the bottom end of the cylinder is near the base portion of the cup.

These and other features, aspects and advantages of the present invention will become better understood with reference to the following drawings, description and claims.

### BRIEF DESCRIPTION OF THE DRAWINGS

FIG. 1 is a perspective view of the present invention;

FIG. 2 is an exploded view of the present invention demonstrating lid removal;

FIG. 3 is a bottom perspective view of the lid of FIG. 1;

FIG. 4 is a detail perspective view of the rim of the cup of FIG. 1;

FIG. 5 is a cutaway view of the present invention;

FIG. 6 is a perspective view of the inner assembly of FIG. 1;

FIG. 7 is a front view of the inner assembly of FIG. 1;

FIG. 8 is a side view of the inner assembly of FIG. 1;

FIG. 9 is a perspective view of the cup of FIG. 1;

FIG. 10 is a perspective view demonstrating the inner assembly in the top first position;

FIG. 11 is a perspective view demonstrating the inner assembly in the bottom second position.

FIG. 12: is an exploded view of the present invention demonstrating insertion a stirrer;

FIG. 13 is a perspective view demonstrating post insertion the stirrer of FIG. 12;

FIG. 14 is a perspective view demonstrating post insertion and rotation of the stirrer;

FIG. 15 is a perspective view of a straw of the present invention; and

FIG. 16 is a perspective cutaway view of the straw of FIG. 15 in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a drink mixer including a cup with an internal cavity. An inner assembly is located within the internal cavity of the cup. The inner assembly includes a hollow cylinder with a hollow coil tube attached to and surrounding the hollow cylinder. The coil tube may include a top opening and a bottom connected to the cylinder and leading into the hollow core of the cylinder. The inner assembly may be in a first position in which the inner assembly is adjacent the opening of the cup, and a second position which the inner assembly is adjacent to the base of the cup. In use, beverages may be poured in the coil tube through the opening, as well as in the hollow core of the cylinder. Ice may also be placed within the hollow core of the cylinder. The inner assembly may be rotated between the first position and the second position to mix the beverage within the cup.

The present invention includes a combination of traditional cocktail mixing equipment and drink-ware forming a fashionable novelty. Utilizing the present invention, each patron may have their own mixing equipment built into the glass. The present invention combines different mechanical and geometric principles into a unique beverage consumption instrument. Bartenders can turn cocktail mixing into entertainment by mixing the drink in front of the patron using the present invention.

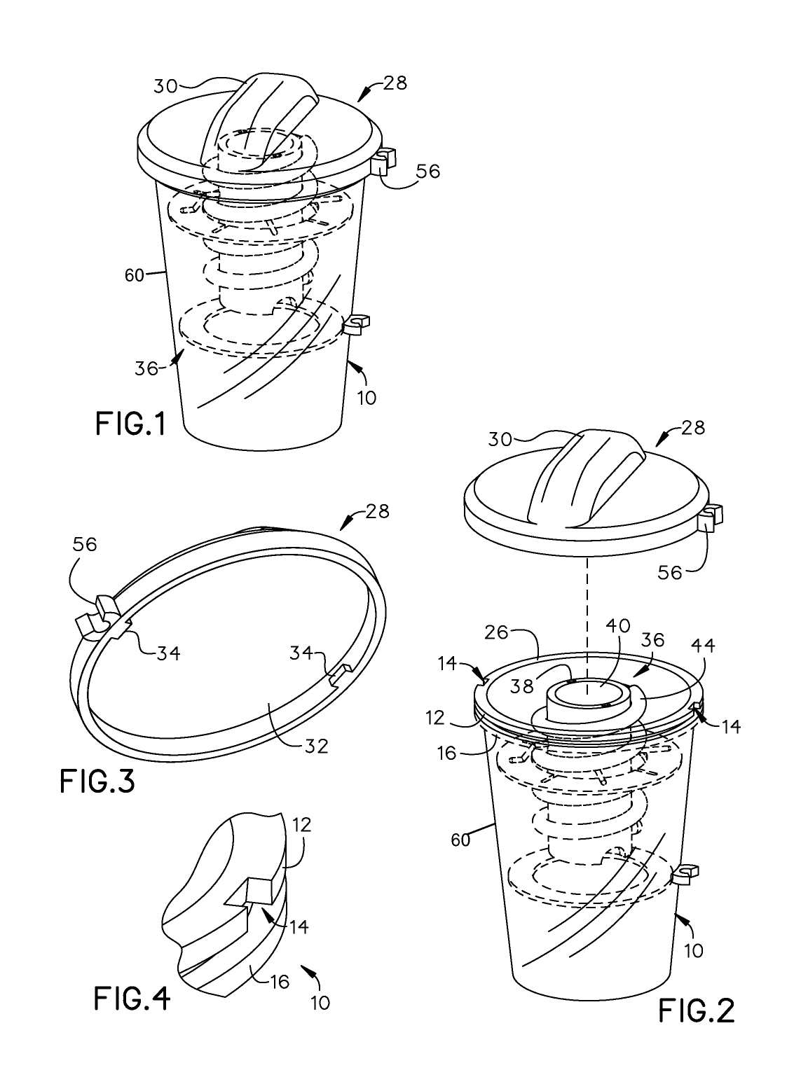

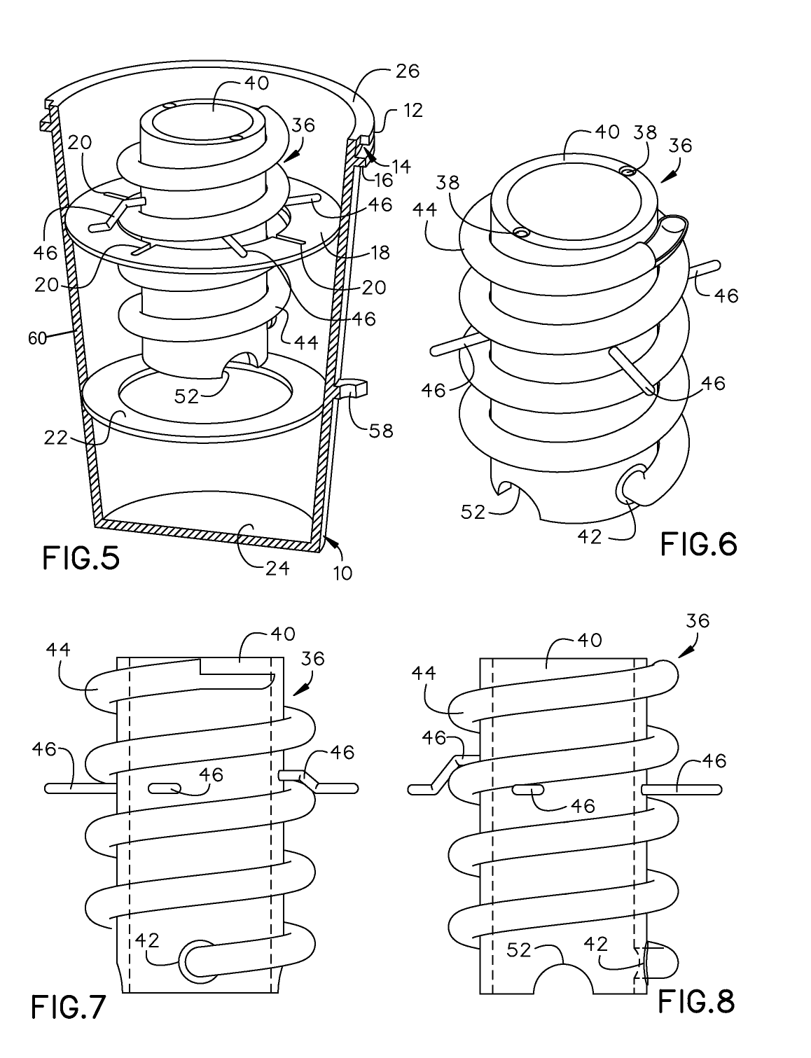

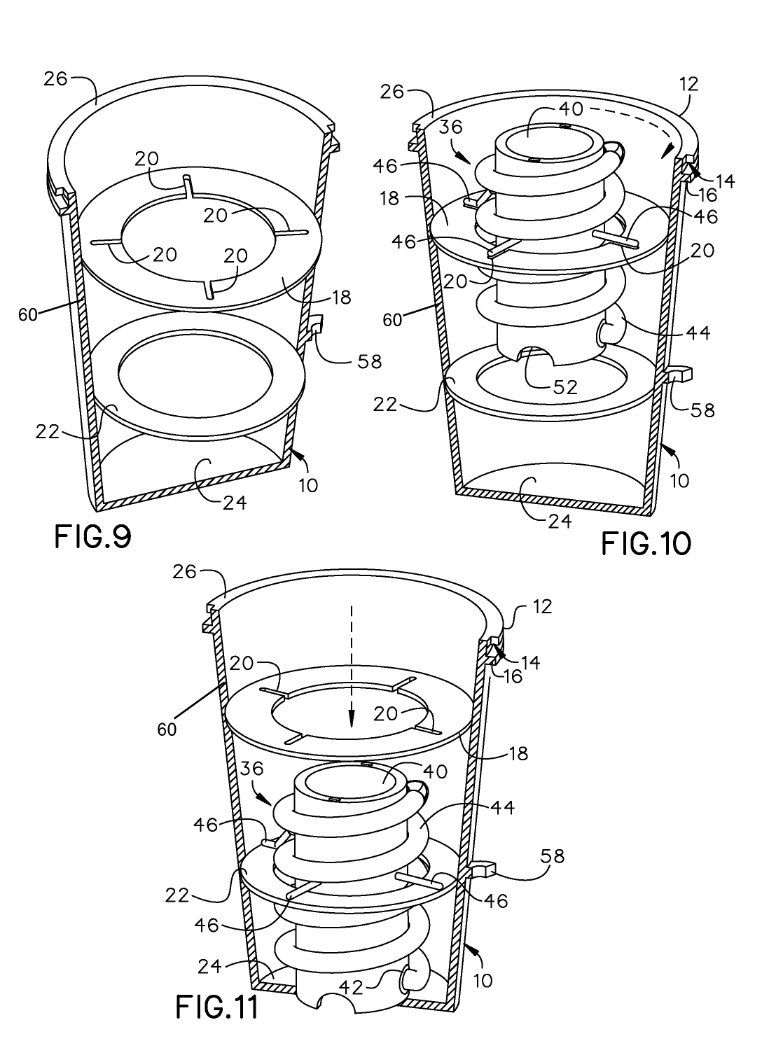

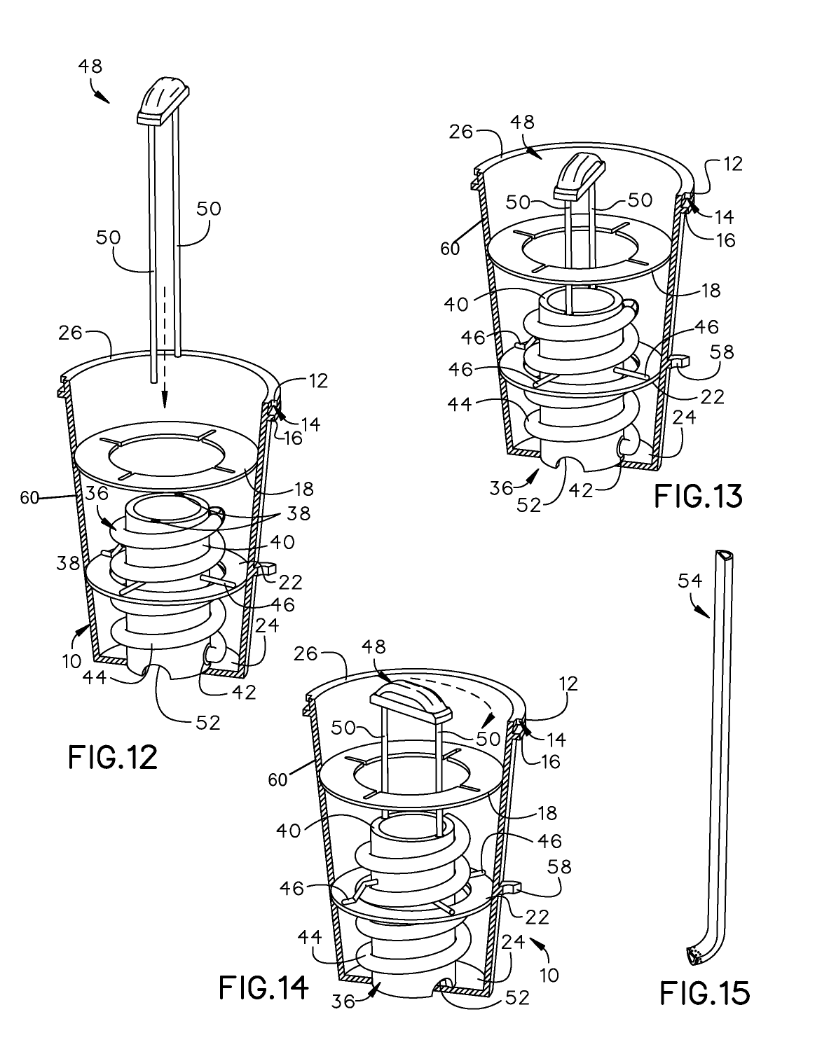

Referring to FIGS. 1 through 16, the present invention includes a drink mixer including a cup 10. The cup 10 may include a base portion 24 and a sidewall 60 attached to and extending from the base portion 24. A rim 26 is formed at the top of the sidewall 60 and forms an opening leading into an internal cavity within the cup 10. A lid 28 may be releasably attachable to the rim 26 of the cup 10 so that user's may close the lid 28 over the opening and shake the beverages within the cup 10.

The lid 28 of the present invention may include a handle portion 30 and a lid seal disc 32 opposite the handle 30. In certain embodiments, the lid 28 may lock into the rim 26 of the cup 10. In such embodiments, the rim 26 may include an outer upper ring 12 and an outer lower ring 16 forming a channel in between. An upper ring slot 14 may be formed through the outer upper ring 12 and lead into the channel. The lid 28 may include at least one lid lock tooth 34, such as a pair of lid lock teeth 34 formed to fit through the upper ring slot 14 and within the channel. The lid 28 may be rotated so that the upper ring slot 14 is locked within the channel and the lid seal disc 32 may be pressed up against the lid 26, sealing the contents of the cup 10 within.

The present invention may further include an inner assembly 36 located within the internal cavity of the cup 10. The inner assembly 36 may include a cylinder 40 and a coil tube 44 surrounding the cylinder 40. The cylinder 40 may include a top end, a bottom end, and a hollow core. An arch slot 52 may be formed at the bottom end of the cylinder 40. A coil tube 44 may include a first end having an opening leading into the coil tube 44 and disposed near the top end of the cylinder 40. The coil tube 44 may further include a second end 42 connected to the cylinder 40 near the bottom end and leading into the hollow core of the cylinder 40. The coil tube 44 may be attached to the cylinder 40 and threaded around the cylinder 40. The cylinder 40 may be placed in a first position in which the top end of the cylinder 40 is near the opening of the cup 10. The cylinder 40 may be placed in a second position so that the bottom end of the cylinder 40 is near the base portion 24 of the cup 10.

In certain embodiments, the present invention may include an upper ledge 18 attached to the cup 10 in the internal cavity having an upper ledge opening through the middle. The present invention may further include a lower ledge 22 attached to the cup 10 in the internal cavity having a lower ledge opening. The cylinder 40 is sized to fit within the upper and lower ledge openings. In such embodiments, the cylinder 40 may be moved from the first position to the second position by rotating the cylinder 40 and thereby threading the coil tube 44 about the upper and lower ledge 18, 22.

In certain embodiments, the present invention may include a plurality of arm supports 46 protruding laterally from the cylinder 40. The plurality of arm supports 46 may be formed to support the cylinder 40 on the upper ledge 18 in the first position and the lower ledge 22 in the second position. In certain embodiments, the upper ledge 18 may include a plurality of slots 20. The plurality of arm supports 46 may fit through the slots 20 during the transition between the first position and the second position.

The present invention may further include a stirrer 48. The stirrer 48 may include a handle portion and a pair of stirrer posts 50 protruding from the handle portion. In such embodiments, the cylinder 40 may include a pair of inner cylinder slots 38 running parallel with the hollow center of the cylinder 40. The pair of stirrer posts 50 may fit within the inner cylinder slots 38. The patron may then rotate the handle portion of the stirrer thereby rotating the cylinder. Therefore, the stirrer 48 may move the cylinder 40 from the first position to the second position and back to the first position.

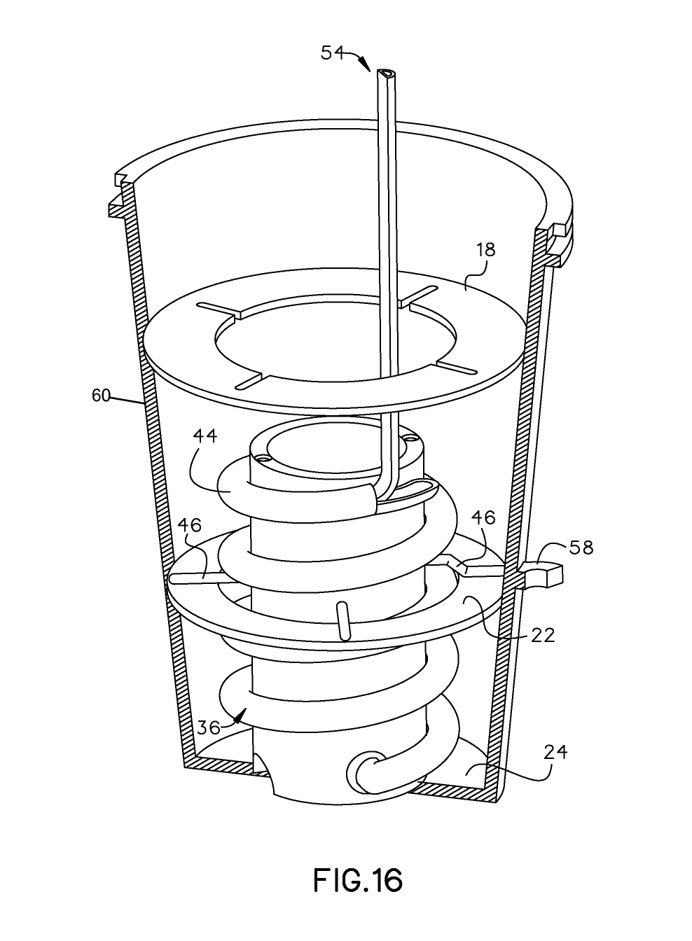

In certain embodiments, the present invention may include a straw 54. In such embodiments, the cup 10 may include a straw holder, such as a lid straw holder 56 aligning with a cup straw holder 58. The straw 54 may include a curved end to that a user may easily place the end of the straw within the open end of the coil tube 44, as illustrated in FIG. 16.

In alternative embodiments, the present invention may include a turning handle similar to pencil sharpener to turn the cylinder 40. The coil tube 44 and cylinder 40 may be shaped in a truncated fashion, narrowing as you approach the base portion 24, so that the inner assembly 36 may slide up and down the ledges 18, 22. There may be alternate methods of configuring the lid 28, such as mating threaded portions and the like.

A method of using the present invention may include the following. While the cylinder 40 is in the first position, a bar tender may pour a mixer into the hollow core of the cylinder 40 or into the opening of the coil tube 44. The bar tender may then pour liquor into the opening of the coil tube 44. Ice may be placed within the hollow core of the cylinder 40. The patron or the bar tender may then rotate the cylinder 40 from the first position to the second position. This may be repeated so that the bottom of the cylinder 40 is adjacent to the base portion 24 of the cup. The arch slots 52 may allow liquid to flow from the hollow core of the cylinder 40 and into the cup 10. During the repetition, the liquor may mix with the mixer. Further, the lid 28 may be attached to the rim of the cup 10, and the cup 10 may be shaken to further mix the drink. Alternatively, the stirrer 48 may be used to rotate the cylinder 40 back and forth from the first position to the second position. Once the drink has been mixed, the user may insert the straw 54 into the tube coil 44 and enjoy their drink.

The present invention may add novelty to the experience of a cocktail drinker. The patron can drink through a straw through the hollow core of the cylinder 40 and watch liquid in the coil tube 44 decrease. Every component may separate and be capable of being run through the dishwasher. Bartenders can make preparing cocktails in these glasses a part of their entertainment routine for patrons, and can make the drink in the glass on the counter right in front of the customer, without having to resort to grabbing shaker cups, strainers and the like.

The present invention may be displayed at bars, clubs and stadium vendors as a single contiguous unit in certain embodiments as follows: When the apparatus is configured as shown in FIG. 14, the lid 30 may be adhered to the slot 14 and turned to enclose all internal mechanisms within cup 10. This may include adjustment of the height of the bridge component of the stirrer 48. Further, in certain embodiments, the northern and southern extremities of straw 54 can be clasped to lid straw holders 56 and 58 such that all mechanisms are connected for attractive marketing displays for customers and patrons.

It should be understood, of course, that the foregoing relates to exemplary embodiments of the invention and that modifications may be made without departing from the spirit and scope of the invention as set forth in the following claims.

What is claimed is:

1. A drink mixer comprising:
a cup comprising a base portion and a sidewall with a rim forming an opening into an internal cavity within the cup;
a cylinder within the internal cavity, the cylinder comprising a top end, a bottom end, and a hollow core; and
a coil tube surrounding the cylinder, wherein the coil tube comprises a first end comprising an opening near the top end of the cylinder, and a second end connected to the cylinder near the bottom end leading into the hollow core;
wherein the cylinder comprises a first position wherein the top end of the cylinder is near the opening of the cup, and a second position, wherein the bottom end of the cylinder is near the base portion of the cup.

2. The drink mixer of claim 1, wherein the coil tube is threaded around the cylinder.

3. The drink mixer of claim 2, further comprising:
an upper ledge attached to the cup in the internal cavity comprising an upper ledge opening;
a lower ledge attached to the cup in the internal cavity comprising a lower ledge opening;
wherein the cylinder is sized to fit within the upper and lower ledge openings, wherein the cylinder moves from the first position to the second position by rotating the cylinder and thereby rotating the coil tube about the upper and lower ledge.

4. The drink mixer of claim 3, further comprising a plurality of arm supports protruding laterally from the cylinder formed to support the cylinder on the upper ledge in the first position and the lower ledge in the second position.

5. The drink mixer of claim 4, wherein the upper ledge comprises a plurality of slots, wherein the plurality of arm supports fit through the slots during a transition between the first position and the second position.

6. The drink mixer of claim 1, further comprising a lid releasably attachable to the rim.

7. The drink mixer of claim 6, wherein the rim comprises an outer upper ring and an outer lower ring forming a channel in between, wherein the outer upper ring comprises an upper ring slot leading into the channel.

8. The drink mixer of claim 7, wherein the lid comprises at least one lid lock tooth formed to fit through the upper ring slot and within the channel.

9. The drink mixer of claim 1, wherein the cylinder comprises a pair of inner cylinder slots running parallel with the hollow center.

10. The drink mixer of claim 9, further comprising a stirrer comprising a handle portion and a pair of stirrer posts protruding from the handle portion and formed to fit within the pair of inner cylinder sots.
